(19) United States
(12) Patent Application Publication
(10) Pub. No.: US 2005/0058810 A1
(43) Pub. Date: Mar. 17, 2005

(54) Absorbent composites comprising superabsorbent materials with controlled rate behavior

(76) Inventors: Richard Norris Dodge II, Appleton, WI (US); Yong Li, Appleton, WI (US); Sridhar Ranganathan, Suwanee, GA (US); Wendy Lynn Van Dyke, Appleton, WI (US); Xiaomin X. Zhang, Appleton, WI (US); Gerd Jonas, Krefeld (DE); Klaus Pflueger, Krefeld (DE)

Correspondence Address: KIMBERLY-CLARK WORLDWIDE, INC., 401 NORTH LAKE STREET, NEENAH, WI, 54956, US

(21) Appl. No.: 10/662,073

(22) Filed: Sep. 12, 2003

(51) Int. Cl. B32B 23/02

(52) U.S. Cl. 428/192

(57) ABSTRACT

The present invention is directed to absorbent composites comprising superabsorbent materials. The superabsorbent material has: an Absorption Time of about 5+10 a² minutes or greater, where a is the mean particle size of the superabsorbent material in millimeters; a capacity of about 15 g/g or greater; a Drop Penetration Value of about 2 seconds or less; and, a ½ Float Saturation of 50% or less. The present invention is further directed to fiber-containing fabrics and webs comprising superabsorbent materials and their applicability in disposable personal care products.

### BACKGROUND OF THE INVENTION

In the manufacture of disposable absorbent products, such as disposable diapers, there is continual effort to improve the performance characteristics of the absorbent product. Although the structure of an absorbent product has many components, in many instances the in-use performance of the absorbent product is directly related to the characteristics of the absorbent composite contained within the absorbent product. Accordingly, absorbent product manufacturers strive to find ways of improving the properties of the absorbent composite, including in-use absorbency, in order to reduce the tendency of the absorbent product to leak.

One means of reducing the leakage of an absorbent product has been the extensive use of superabsorbent materials. Recent trends in commercial absorbent product designs have been to use more superabsorbent materials and less fiber in order to make the absorbent product thinner. However, notwithstanding the increase in total absorbent capacity contributed by the addition of larger amounts of superabsorbent material, such absorbent product often still suffer from excessive leaking during use.

One reason that diapers with a high content of superabsorbent materials may still leak is that many superabsorbent materials are unable to absorb liquid at the rate at which the liquid is applied to or insults the absorbent composite during use. The addition of fibrous material to the absorbent composite may improve the leakage control of an absorbent composite by temporarily holding the liquid until the superabsorbent material absorbs the liquid. Fibers may also serve to separate the particles of superabsorbent material so that gel-blocking does not occur. As used herein, the term “gel-blocking” refers to the situation wherein the particles of superabsorbent material deform during swelling and block the interstitial spaces between the particles, or between the particles and the fibers, thus preventing the flow of liquid through the interstitial spaces. Even when fibrous material is incorporated into an absorbent composite, a poor choice of a superabsorbent material, especially one which exhibits gel-blocking behavior within the absorbent composite, may result in poor liquid handling properties initially and later in the life cycle of the absorbent composite. Consequently, the choice of a particular superabsorbent material may greatly affect the in-use absorbency and leakage of the absorbent product.

Another problem that may be associated with commercially available absorbent products, such as diapers, may be the tendency of the absorbent products to leak after multiple insults. As used herein, the term “insult” refers to a single introduction of liquid into the absorbent composite or diaper. During use, an absorbent product is typically exposed to multiple insults during the life cycle of the absorbent product. To reduce absorbent product leakage during the life cycle of the absorbent product, it is desirable to maintain the level of intake performance of the absorbent composite throughout the life of the absorbent product.

A number of U.S. patents address different issues associated with absorbent composites. For example, U.S. Pat. No. 5,147,343 issued to Kellenberger discloses a superabsorbent with high Absorbency Under Load values in an absorbent product. U.S. Pat. No. 5,149,335 issued to Kellenberger et al. discusses superabsorbent rate and capacity in an absorbent composite. U.S. Pat. No. 5,415,643 issued to Melius et al. discloses AUL values under different pressures.

The aforementioned patents disclose specific superabsorbent properties. In general, the aforementioned patents disclose superabsorbent materials exhibiting high capacity under load result in improved gel stiffness and permeability behavior for enhanced composite performance. However, there is still room for improvement to the problems mentioned above specifically, namely, improving leakage/intake over the life cycle of the absorbent composite and/or absorbent product.

Accordingly, what is needed in the art is a method of determining which superabsorbent materials provide optimum composite properties. What is also needed in the art is an absorbent composite containing superabsorbent materials, which exhibits improved fluid distribution, improved leakage protection, and superior fluid intake of multiple insults over the life of the absorbent composite, without the problems that may be associated with known absorbent composites.

### SUMMARY OF THE INVENTION

The present invention is directed to absorbent composites comprising superabsorbent materials, which may address the above-described problems associated with currently available absorbent composites. The absorbent composites of the present invention may comprise superabsorbent materials, where the superabsorbent materials have: an Absorption Time of about 5+10 a² minutes or greater, where a is the mean particle size of the superabsorbent material in millimeters; a capacity as measured by the FAUZL test of about 15 g/g or greater; a Drop Penetration Value of about 2 seconds or less; and, a ½ Float Saturation of about 50% or less. Such a combination of properties for superabsorbent materials may enable an absorbent composite to provide beneficial behavior in terms of not locking up all the liquid in the vicinity of where liquid enters the absorbent product thus providing better liquid distribution and maintaining a lower level of saturation in the target area to provide a more intake-friendly structure for a longer portion of the absorbent composite life. Unlike some known absorbent composites, which lose their fluid intake performance over the life of the absorbent composite, the absorbent composites of the present invention may exhibit superior liquid distribution and fluid intake after multiple insults to the absorbent composite.

The present invention may be further directed to absorbent composites comprising superabsorbent materials and fibrous material, and their applicability in disposable personal care absorbent products. The absorbent composites of the present invention may be useful as absorbent components in personal care absorbent products such as diapers, feminine pads, panty liners, incontinence products, and training pants.

### BRIEF DESCRIPTION OF THE FIGURES

FIG. 1 is a representation of the Gel Bed Permeability and Absorption Time on composite intake behavior for superabsorbent materials of the present invention.

FIG. 2 is an illustration of equipment for determining the Flooded Absorbency Under Zero Load (FAUZL) value of a superabsorbent material.

FIG. 3 is a cross-sectional view of a portion of the equipment for determining the Flooded Absorbency Under Zero Load (FAUZL) value shown in FIG. 2 and taken along section line B-B.

FIG. 4 is a cross-section view of a portion of the equipment for determining the Flooded Absorbency Under Zero Load (FAUZL) value shown in FIG. 2 and taken along section line A-A.

FIG. 5 is an illustration of equipment for determining the Gel Bed Permeability (GBP) value of a superabsorbent material.

FIG. 6 is a cross-sectional view of the piston head taken along line 12-12 of FIG. 5.

FIG. 7 is an illustration of equipment for determining the Fluid Intake Flowback Evaluation (FIFE) value of an absorbent composite.

FIG. 8 is an illustration of equipment for determining the Intake/Desorption value of an absorbent composite.

### DETAILED DESCRIPTION OF EMBODIMENTS OF THE PRESENT INVENTION

The superabsorbent materials of the present invention may include a range of superabsorbent properties in terms of Absorption Time, Mean Particle Size, Capacity, and chemical stability of any treatment that provide desirable absorbent composite behavior. The conventional approaches to achieving a large Absorption Time, including utilization of larger particle size, hydrophobic coating, or use of non-absorbent materials, may have inherent deficiencies that prevent the superabsorbent materials from achieving the range of superabsorbent properties identified in the present invention to provide improved absorbent composite performance.

As used herein, the term “superabsorbent material” (SAM) refers to a water-swellable, water-insoluble organic or inorganic material capable, under the most favorable conditions, of absorbing about 15 times or greater its weight in an aqueous solution containing 0.9 weight percent sodium chloride. Organic materials suitable for use as a superabsorbent material of the present invention may include natural materials such as agar, pectin, guar gum, and the like; as well as synthetic materials, such as synthetic hydrogel polymers. Such hydrogel polymers may include, but are not limited to, alkali metal salts of polyacrylic acids, polyacrylamides, polyvinyl alcohol, ethylene maleic anhydride copolymers, polyvinyl ethers, hydroxypropylcellulose, polyvinylmorpholinone; and, polymers and copolymers of vinyl sulfonic acid, polyacrylates, polyacrylamides, polyvinylpyrridine, and the like. Other suitable polymers may include, but are not limited to, hydrolyzed acrylonitrile grafted starch, acrylic acid grafted starch, and isobutylene maleic anhydride copolymers and mixtures thereof. The hydrogel polymers may be suitably lightly crosslinked to render the superabsorbent material substantially water insoluble. Crosslinking may, for example, be by irradiation or by covalent, ionic, van der Waals, or hydrogen bonding. The superabsorbent materials may be in any form suitable for use in absorbent composites including particles, fibers, flakes, spheres, and the like.

While a wide variety of superabsorbent materials are known, the present invention may relate to superabsorbent materials having properties which allow formation of improved absorbent composites and disposable absorbent products. The present invention may be directed to a method of achieving improved performance in an absorbent composite by incorporation of superabsorbent materials having: an Absorption Time of about 5+10 a² minutes or greater, where a is the mean particle size of the superabsorbent material in millimeters; a capacity of about 15 g/g or greater; a Drop Penetration Value of about 2 seconds or less; and, a ½ Float Saturation of about 50% or less. More specifically, superabsorbent materials of the present invention may have a combination of properties including: an Absorption Time of about 5+10 a² minutes or greater, where a is the mean particle size of the superabsorbent material in millimeters; a capacity of about 15 g/g or greater; a Drop Penetration Value of about 2 seconds or less; and, a ½ Float Saturation of about 50% or less, thereby providing desirable properties and performance of the absorbent composites incorporating such superabsorbent materials. These absorbent composites also comprising slower absorption rate superabsorbent materials may demonstrate the capability of delivering improved fluid distribution as described below.

Superabsorbent materials having a slow absorption rate, combined with the properties discussed above, may be suitably used in absorbent composites and/or absorbent products. The slow absorption rate of the superabsorbent material may allows the liquid coming into the absorbent composite to move to remote regions from the target area prior to being locked up by the superabsorbent material. As used herein, the term “Target area” refers to the immediate vicinity of where liquid enters the absorbent product. Absorbent composites incorporating such superabsorbent materials may be able to achieve higher utilization of the absorbent capacity of the absorbent in an absorbent product. Also, superabsorbent materials having a slower absorbent rate, when used in the target area, may be able to reduce the tendency of the target area from reaching its absorbent capacity prematurely and thus reduce leakage of the absorbent product.

The superabsorbent materials of the present invention materials may be divided into two categories: those having (1) an Absorption Time of about 5+10 a² minutes or greater, where a is the mean particle size of the superabsorbent material in millimeters; a capacity of about 15 g/g or greater; a Drop Penetration Value of about 2 seconds or less; and, a ½ Float Saturation of about 50% or less (Class-I superabsorbents), and the rest (Class-II superabsorbents). Use of Class I superabsorbents having relatively high capacity and Absorption Time (AT) and low Drop Penetration Value (DPV) may provide the unexpectedly improved fluid handling behavior described below. Class I superabsorbents may optionally have a Gel Bed Permeability of about 20×10⁻⁹ cm² or greater. More suitably, Class I superabsorbent materials may have a Gel Bed Permeability about 50×10⁻⁹ cm² or greater and even more suitably, Class I superabsorbent material may have a Gel Bed Permeability of about 80×10⁻⁹ cm² or greater.

Class I superabsorbent materials may have an Absorption Time of about 7+10 a² minutes or greater, where a is the mean particle size of the superabsorbent material in millimeters; a capacity of about 15 g/g or greater; a Drop Penetration Value of about 2 seconds or less; and, a ½ Float Saturation of about 50% or less, and more suitably, the superabsorbent materials may have an Absorption Time of about 10+10 a² minutes or greater, where a is the mean particle size of the superabsorbent material in millimeters; a capacity of about 15 g/g or greater; a Drop Penetration Value of about 2 seconds or less; and, a ½ Float Saturation of about 50% or less. Also, the Class I superabsorbent materials may have an Absorption Time of about 5+10 a² minutes or greater, where a is the mean particle size of the superabsorbent material in millimeters; a capacity of about 20 g/g or greater; a Drop Penetration Value of about 2 seconds or less; and, a ½ Float Saturation of about 50% or less, and more suitably, the superabsorbent materials may have an Absorption Time of about 5+10 a² minutes or greater, where a is the mean particle size of the superabsorbent material in millimeters; a capacity of about 25 g/g or greater; a Drop Penetration Value of about 2 seconds or less; and, a ½ Float Saturation of about 50% or less. Additionally, the Class I superabsorbent materials suitably may have a Drop Penetration Value of about 1 second or less. Additionally, the Class I superabsorbent materials suitably may have a ½ Float Saturation of about 15% or less.

The present invention may be further directed to absorbent composites comprising one or more Class I superabsorbent materials described above. The Class I superabsorbent materials may be used alone or in combination with one or more Class II superabsorbent materials. In addition to the superabsorbent materials described above, the absorbent composites of the present invention may also comprise means to contain the superabsorbent material. Any means capable of containing the above-described superabsorbent materials, wherein such means is further capable of being located in a disposable absorbent product, may be suitable for use in the present invention. Many such containment means are known to those skilled in the art. For example, the containment means may comprise a fibrous matrix such as an air-laid or wet-laid web of cellulosic fibers, a meltblown web of synthetic polymeric fibers, a spunbonded web of synthetic polymeric fibers, a coformed matrix comprising cellulosic fibers and fibers formed from a synthetic polymeric material, air-laid heat-fused webs of synthetic polymeric material, open-celled foams, and the like.

In one embodiment of the present invention, the absorbent composite comprising superabsorbent materials of the present invention may be placed essentially throughout the entire absorbent composite and/or absorbent product. In another embodiment of the present invention, the superabsorbent materials within the absorbent composite may be present primarily in the target area in the immediate proximity of where liquid enters the absorbent product. In yet another embodiment of the present invention, the superabsorbent materials in the absorbent composite may be incorporated primarily away from the target area.

The absorbent composite may be formed by mixing the superabsorbent materials in an essentially homogeneous manner.

Alternatively, the containment means may comprise two layers of material which are joined together to form a pocket or compartment, more particularly a plurality of pockets, wherein at least one pocket may contain superabsorbent material of the present invention. The superabsorbent material may be isolated into pockets thus forming regions rich in superabsorbent material and regions poor in superabsorbent material. In such a case, at least one of the layers of material may be water-pervious. The second layer of material may be water-pervious or water-impervious. The layers of material may be cloth-like wovens and nonwoven, closed or open-celled foams, perforated films, elastomeric materials, or may be fibrous webs of material. When the containment means comprises layers of material, the material may have a pore structure small enough or tortuous enough to contain the majority of the superabsorbent material. The containment means may also comprise a laminate of two layers of material between which the superabsorbent material is located and contained. Further, the containment means may comprise a support structure, such as a polymeric film, on which the superabsorbent material may be affixed. The superabsorbent material may be affixed to one or both sides of the support structure, which may be water-pervious or water-impervious.

Suitably, the absorbent composites of the present invention may comprise superabsorbent material in combination with a fibrous matrix containing one or more types of fibrous materials. The fibrous material forming the absorbent composites of the present invention may be selected from a variety of materials including natural fibers, synthetic fibers, and combinations thereof. A number of suitable fiber types are disclosed in U.S. Pat. No. 5,601,542, assigned to Kimberly-Clark Corporation, the entirety of which is incorporated herein by reference. The choice of fibers depends upon, for example, the intended end use of the finished absorbent composite. For instance, suitable fibrous materials may include, but are not limited to, natural fibers such as cotton, linen, jute, hemp, wool, wood pulp, etc. Similarly, regenerated cellulosic fibers such as viscose rayon and cuprammonium rayon, modified cellulosic fibers, such as cellulose acetate, or synthetic fibers such as those derived from polyesters, polyamides, polyacrylics, etc., alone or in combination with one another, may likewise be used. Blends of one or more of the above fibers may also be used if so desired.

The absorbent composites of the present invention may be made by any process known to those of ordinary skill in the art. In one embodiment of the present invention, the superabsorbent material may be incorporated into an existing fibrous substrate. Suitable fibrous substrates include, but are not limited to, nonwoven and woven fabrics. In many embodiments of the present invention, particularly personal care products, preferred substrates are nonwoven fabrics. As used herein, the term “nonwoven fabric” refers to a fabric that has a structure of individual or bundled fibers or filaments randomly arranged in a mat-like fashion. Nonwoven fabrics may be made from a variety of processes including, but not limited to, air-laid processes, wet-laid processes, hydroentangling processes, staple fiber carding and bonding, and solution spinning. The superabsorbent material may be incorporated into the fibrous substrate as a solid particulate material. The absorbent composite may also include specialty pulp fibers, such as mercerized or chemically cross-linked pulp or synthetic fibers. The superabsorbent materials may be in any form suitable for use in absorbent composites including particles, fibers, flakes, spheres, and the like.

In another embodiment of the present invention, the superabsorbent material and fibrous material are simultaneously mixed to form an absorbent composite. Suitably, the absorbent composite materials are mixed by an air-forming process known to those of ordinary skill in the art. Air-forming the mixture of fibers and superabsorbent material is intended to encompass both the situation wherein preformed fibers are air-formed with the superabsorbent material, as well as, the situation in which the superabsorbent material is mixed with the fibers as the fibers are being formed, such as through a meltblowing process.

In should be noted that the superabsorbent material may be distributed uniformly within the absorbent composite or may be non-uniformly distributed within the absorbent composite. The superabsorbent material may be distributed throughout the entire absorbent composite or may be distributed within a small, localized area of the absorbent composite.

The absorbent composites of the present invention may be formed from a single layer of absorbent material or multiple layers of absorbent material. In the case of multiple layers, the layers may be positioned in a side-by-side or surface-to-surface relationship and all or a portion of the layers may be bound to adjacent layers. In those instances where the absorbent composite includes multiple layers, the entire thickness of the absorbent composite may contain one or more superabsorbent materials or each individual layer may separately contain some or no superabsorbent materials. Each individual layer may also contain different superabsorbent materials from an adjacent layer.

The absorbent composites according to the present invention are suited to absorb many fluids including body fluids such as urine, menses, nasal fluid, and blood, and are suited for use in absorbent products such as diapers, adult incontinence products, bed pads, and the like; in catamenial devices such as sanitary napkins, tampons, and the like; and in other absorbent products such as tissues, wipes, bibs, wound dressings, food packaging, and the like. Accordingly, in another embodiment, the present invention may relate to a disposable absorbent product comprising an absorbent composite as described above. A wide variety of absorbent products are known to those skilled in the art. The absorbent composites of the present invention may be incorporated into such known absorbent products. Exemplary absorbent products are generally described in U.S. Pat. No. 4,710,187 issued on Dec. 1, 1987, to Boland et al.; U.S. Pat. No. 4,762,521 issued on Aug. 9, 1988, to Roessler et al.; U.S. Pat. No. 4,770,656 issued on Sep. 13, 1988, to Proxmire et al.; and, U.S. Pat. No. 4,798,603 issued on Jan. 17, 1989, to Meyer et al., the disclosures of which are incorporated herein by reference.

The absorbent products according to the present invention may comprise a body-side liner adapted to contact the skin of a wearer, an outer cover superposed in facing relation with the liner, and an absorbent composite, such as those described above, superposed on the outer cover and located between the body-side liner and the outer cover.

Those skilled in the art will readily understand that the superabsorbent materials and absorbent composites of the present invention may be advantageously employed in the preparation of a wide variety of absorbent products, including but not limited to, absorbent personal care products designed to be contacted with body fluids. Such absorbent products may only comprise a single layer of the absorbent composite or may comprise a combination of elements as described above. Although the superabsorbent materials and absorbent composites of the present invention may be particularly suited for personal care absorbent products, the superabsorbent materials and absorbent composites may be advantageously employed in a wide variety of consumer absorbent products.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

The following examples and comparative examples utilize a variety of different superabsorbent materials, some of which are Class I superabsorbent materials (as described above) and some of which are Class II superabsorbent materials (those which are not in Class I).

### Example 1

A solution of 28 wt % acrylic acid in water is neutralized with sodium hydroxide to a degree of 60 mole % and with calcium hydroxide a further 10 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 2

A solution of 28 wt % acrylic acid in water is neutralized with sodium hydroxide to a degree of 50 mole % and with calcium hydroxide a further 20 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 3

A solution of 28 wt % acrylic acid in water is neutralized with sodium hydroxide to a degree of 30 mole % and with calcium hydroxide a further 40 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 4

A solution of 28 wt % acrylic acid in water is neutralized with sodium hydroxide to a degree of 40 mole % and with magnesium hydroxide a further 30 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 5

A solution of 28 wt % acrylic acid in water is neutralized with sodium hydroxide to a degree of 30 mole % and with calcium hydroxide a further 40 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

The particles were further sieved to a particle size of 150 to 300 microns.

### Example 6

A solution of 28 wt % acrylic acid in water is neutralized with sodium hydroxide to a degree of 55 mole % and with calcium hydroxide a further 15 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 7

A solution of 28 wt % acrylic acid in water is neutralized with sodium hydroxide to a degree of 50 mole % and with magnesium hydroxide a further 20 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

### Example 8

A solution of 28 wt % acrylic acid in water is neutralized with sodium hydroxide to a degree of 65 mole % and with calcium hydroxide a further 5 mole % under constant cooling to maintain a temperature less than 40° C. 0.24 wt % polyethyleneglycol (300) diacrylate and 0.3 wt % allyloxypolyethyleneglycol-acrylate are added to the partially neutralized acrylic acid solution. After cooling to 5° C. and stripping the oxygen with nitrogen, the mixture is polymerized with standard radical chain polymerization techniques by the addition of 10 ppm ascorbic acid, 100 ppm 2,2′-azobis-(2-amidinopropane)dihydrochloride, 70 ppm hydrogen peroxide and 300 ppm sodium persulfate.

After completion of the polymerization (about 30 minutes), the resulting gel-like block is cut into small pieces and extruded through a die with 10 mm holes. The gel particles are then dried at 150° C. for 120 minutes in a forced air oven, reversing the air flow orientation to the polymer 180° after 30 minutes. The dried polymer is milled with a Retsch pin grinder and sieved to a particle size of 150 to 850 microns.

The base polymer is then uniformly coated with 6.5 wt % of a solution containing 7.7 wt % ethylene carbonate, 30.8 wt % water and 61.5 wt % acetone. The coated polymer was then heated to 180° C. for 25 minutes.

Table 1 summarizes the material characteristics of these and other superabsorbent materials.

TABLE 1

| | | | | | | Measured | Drop | | |
|---|---|---|---|---|---|---|---|---|---|
| | Equilibrium | Mean | Calculated | Calculated | Calculated | Absorption | Penetration | Gel Bed | ½ Float |
| Example | FAUZL | particle | 5 + 10a² | 7 + 10a² | 10 + 10a² | Time | Value | Permeability | Saturation |
| Number | Capacity (g/g) | size (mm) | (min) | (min) | (min) | (min) | (sec) | (×10⁻⁹ cm²) | (%) |
| 1 | 30.5 | 0.50 | 7.5 | 9.5 | 12.5 | 12.5 | <1 | 22 | 0 |
| 2 | 29.5 | 0.46 | 7.1 | 9.1 | 12.1 | 47 | <1 | 36 | 0 |
| 3 | 25.0 | 0.42 | 6.8 | 8.8 | 11.8 | 96.5 | <1 | 14 | 0 |
| 4 | 34.8 | 0.73 | 10.3 | 12.3 | 15.3 | 32.5 | <1 | 5 | 0 |
| 5 | 25.5 | 0.23 | 5.5 | 7.5 | 10.5 | 79.4 | <1 | — | 0 |
| 6 | 31.0 | 0.47 | 7.2 | 9.2 | 12.2 | 30 | <1 | 45 | 0 |
| 7 | 29.3 | 0.43 | 6.8 | 8.8 | 11.8 | 8 | <1 | 18 | 0 |
| 8 | 36.0 | 0.47 | 7.2 | 9.2 | 12.2 | 8 | <1 | 92 | 0 |
| C1 | 37 | 0.46 | 7.1 | 9.1 | 12.1 | 4 | <1 | 79 | 0 |
| C2 | 23.1 | 0.45 | 7.0 | 9.0 | 12.0 | 4.6 | | | |
| C3 | 9.1 | 0.45 | 7.0 | 9.0 | 12.0 | 8.6 | | | |
| C4 | | 0.40 | 6.6 | 8.6 | 11.6 | 3.8 | | | Dry Float = 0* |
| C5 | | | | | | | >2 | | Dry Float >90%* |
| C6 | | | | | | | >100 | | Dry Float >90%* |
| C7 | 35 | 0.20 | 5.4 | 7.4 | 10.4 | 3.4 | | | |
| C8 | 42.5 | 0.73 | 10.3 | 12.3 | 15.3 | 9.5 | | | |
| C9 | 27.5 | 0.20 | 5.4 | 7.4 | 10.4 | 3.3 | | | 0 |
| C10 | 33 | 0.73 | 10.3 | 12.3 | 15.3 | 6.4 | | | 0 |
| C11 | 34.2 | 0.45 | 7.0 | 9.0 | 12.0 | 8.1 | <1 | | 100 |

*Dry Float in the above Table 1 indicates the percentage of particles which float on saline when the superabsorbent particles are in the dry, unswollen state.

In Table 1, for samples identified as 1-8, C1, and C11, the Drop Penetration Value is shown as “<1” seconds. This indicates the drop penetrated into the composite nearly instantaneously. For samples identified as C2, C3, C4, C7, C8, C9, and C10 since the Absorption Time measured was less than the 5+10a² minutes limitation, the Drop Penetration Value was not determined for composites containing these superabsorbent materials. For the samples identified as C5 and C6, since the Drop Penetration Value was greater than the 2 second limitation, the Absorption Time was not determined for these superabsorbent materials. For sample C11, since the ½ Float Saturation was greater than 50%, the Gel Bed Permeability was not determined for this superabsorbent material.

### Comparative Examples

Superabsorbents identified as C1, C9-C11 are available from Stockhausen Inc., Greensboro, N.C. Superabsorbent C1 is FAVOR SXM 880, a lightly crosslinked, partially neutralized, sodium polyacrylate polymer available from Stockhausen, Inc. Superabsorbents C2 and C3 were prepared as set forth in U.S. Pat. No. 4,548,847 (discussed in further detail below). Superabsorbent C4 is IM-5000 a lightly crosslinked, partially neutralized, sodium polyacrylate polymer available from Hoescht-Celanese (now BASF) of Portsmouth, Va. Superabsorbents C5 and C6 are hydrophobic surface treatment modifications to superabsorbent C4 based on the teachings from WO 9847951 (discussed in further detail below). Superabsorbents C7 and C8 are Aqualic CA-W4 available from Nippon Shokubai Co., Osaka, Japan (discussed in further detail below). Superabsorbent C7 was prepared by sieving a sample of Aqualic CA-W4 and collecting that material which was retained upon a #140 U.S. Standard Sieve but passed through a #50 U.S. Standard Sieve. Superabsorbent C8 was prepared by sieving a sample of Aqualic CA-W4 and collecting that material which was retained upon a #30 U.S. Standard Sieve but passed through a #20 U.S. Standard Sieve. Superabsorbents C9 and C10 are FAVOR SXM 870, a lightly crosslinked, partially neutralized, sodium polyacrylate polymer available from Stockhausen, Inc. Superabsorbent C9 was prepared by sieving a sample of FAVOR SXM 870 and collecting that material which was retained upon a #140 U.S. Standard Sieve but passed through a #50 U.S. Standard Sieve. Superabsorbent C10 was prepared by sieving a sample of FAVOR SXM 870 and collecting that material which was retained upon a #30 U.S. Standard Sieve but passed through a #20 U.S. Standard Sieve. Superabsorbent C11 is W77553 (P15087), a lightly crosslinked, partially neutralized, sodium polyacrylate polymer with a hydrophobic coating available from Stockhausen, Inc.

U.S. Pat. No. 4,548,847 discloses the use of reversibly cross linking a weakly cross linked or non-crosslinked anionic polyelectrolyte with a polyvalent cation of valence of at least two. Due to the presence of the multivalent ions that provide the reversible cross links in the polymer, a cation complexing agent is required to remove these and let the polymer swell in aqueous liquids. Several combinations of Calcium Chloride add-on level and sodium polyphosphate cation removal agent were used with IM 5000 SAM (available from Hoechst Celanese now part of BASF, Portsmouth, Va.) to understand the limits of this patent. It was seen that as the Calcium Chloride treatment level increased, the capacity of the SAM decreased, as expected. To these treated superabsorbent materials, as the cation removal agent was added, some of the capacity was regained. However, on a per mass basis, the gain in capacity due to addition of the cation removal agent was more than off set by the extra mass of material that needed to be used, in most cases.

The ultimate swelling capacity (3 hour value) is shown in Table 2 for various amounts CaCl₂ add-on and at different amounts of cation removal agent present.

TABLE 2
Swelling Capacity

| | Calcium | |
|---|---|---|
| Cation Removal | Chloride Add- | |
| Agent (gm/0.16 gm | On Level | Swelling |
| of SAM) | (moles/liter) | Capacity (g/g) |
| 0 | 0.005 | 33.1 |
| 0 | 0.011 | 31.1 |
| 0 | 0.09 | 4.53 |
| 0.05 | 0.005 | 24.8 |
| 0.05 | 0.011 | 23.1 |
| 0.05 | 0.09 | 9.5 |
| 0.1 | 0.005 | 19.5 |
| 0.1 | 0.011 | 18.5 |
| 0.1 | 0.09 | 10.9 |
| 0.19 | 0.005 | 13 |
| 0.19 | 0.011 | 13 |
| 0.19 | 0.09 | 10.5 |
| 0.28 | 0.005 | 9.5 |
| 0.28 | 0.011 | 9.0 |
| 0.28 | 0.09 | 8.1 |
| 0.375 | 0.005 | 9.3 |
| 0.375 | 0.011 | 9.1 |
| 0.375 | 0.09 | 7.7 |

Ultimate swelling capacity of less than about 15 g/g is deemed too low for practical use. The 0.09 moles/liter of DI water CaCl₂ add-on does not satisfy the swelling capacity restriction in conjunction with any amount of cation removal agent. Therefore, the focus was placed only on the 0.011 moles/liter DI water CaCl₂ add-on. The swelling kinetics of the CaCl₂ treated superabsorbent material and cation removal agent system were studied using the FAUZL test. The absorption time values obtained for various cation removal agent add-on levels are provided in Table 3.

TABLE 3
Absorption Time using 0.011 moles/liter Calcium Chloride add-on

| | Cation removal | | |
|---|---|---|---|
| | agent | Swelling | Absorption |
| | (gm/0.16 gm of | Capacity | Times |
| Conditions | SAM) | (g/g) | (min) |
| 1 | 0 | 31.1 | 4.4 |
| 2* | 0.05 | 23.1 | 4.6 |
| 3 | 0.1 | 18.5 | 4.9 |
| 4 | 0.19 | 13.0 | —*** |
| 5 | 0.28 | 9.0 | —*** |
| 6** | 0.375 | 9.1 | 8.6 |

*(Superabsorbent Identification C2 on Table 1)
**(Superabsorbent Identification C3 on Table 1)
***Since the Swelling Capacity of these samples are less than 15 g/g limitation, the Absorption Time was not determined.

Absorption time for this mean particle size (400 microns) would need to be greater than 6.6 min to be within the scope of the present invention based on the 5+10a² limitation. It is seen that only at the highest cation removal agent add-on level was the superabsorbent material slow enough to satisfy this condition. However, at that point the capacity of the superabsorbent material has decreased to about 9 g/g. Therefore, one does not obtain a controlled-rate superabsorbent material of the present invention. As can be seen in Table 3, there are no common points for the two lines above the threshold values of 6.6 min absorption time value and 15 g/g SAM capacity.

Patent Application GB-2,280,115 A (Steger et al) describes the use of a delayed swelling superabsorbent material. It discloses the use of encapsulation methods to delay the onset of swelling of superabsorbent materials. The encapsulating material may dissolve or permit fluid entry slowly. Encapsulating of the superabsorbent materials in gelatin like materials which was shown to be insufficient to reduce the rates to the level shown in the present invention. Gelatin was coated over a commercial superabsorbent material (Drytech 2035 available from Dow Chemical Company (Midland, Mich.) to a 20% and 50% by weight of superabsorbent material. The resulting coated superabsorbent material particles were tested according to the FAUZL test. At the end of 5 minutes, about 75% and 70% of the capacity of the superabsorbent materials were reached for the two coating levels, respectively. This swelling rate would correspond to an Absorption time of less than 5 minutes. For the particle size used in this comparative example (mean particle size of 0.45 mm), the 5+10 a² limit would be 7.0 minutes, outside of the Absorption Time of about 5+10 a² minutes or greater of the superabsorbent materials of the present invention.

U.S. Pat. No. 5,762,641 (Plischke et al.) describes the use of superabsorbent materials with different rates in a dual layer absorbent system. It discloses the use a superabsorbent material in the upper layer of the dual layer absorbent that is not greater than ⅔ as fast as the superabsorbent material in the lower layer which has to have a Dynamic Swelling Rate (DSR) greater than 0.2 g/g/s. Samples identified as C7 and C8 in Table 1 are superabsorbent materials that are taught in U.S. Pat. No. 5,762,641. These superabsorbent materials were tested according to the Mean Particle Size and Flooded Absorbency Under Zero Load tests described in more detail below. As can be seen from Table 1, the results of this testing show that these materials have an Absorption Time less than the 5+10a² minutes limitation of this invention.

Table 4 lists the Absorption Time of several superabsorbent materials including those from U.S. Pat. No. 5,762,641 and FAVOR SXM 880 (superabsorbent identified as C1 in Table 1), available from Stockhausen Inc., Greensboro, N.C. Also included in Table 4 is the Absorption Time of several superabsorbent materials that are part of the present invention. Table 4 shows that there may be a wide variety of rates for any given particle size.

TABLE 4
Absorption Time of Several Superabsorbents

| Superabsorbent | Particle | | Absorption |
|---|---|---|---|
| Identification | Size | 5 + 10a² | Time |
| (from Table 1) | (mm) | (min) | (min) |
| 1 | 0.50 | 7.5 | 12.5 |
| 2 | 0.46 | 7.1 | 47 |
| 3 | 0.42 | 6.8 | 96.5 |
| 4 | 0.45 | 7.0 | 32.5 |
| 5 | 0.23 | 5.5 | 79.4 |
| 6 | 0.47 | 7.2 | 30 |
| 7 | 0.43 | 6.8 | 8 |
| 8 | 0.47 | 7.2 | 8 |
| C1 | 0.40 | 6.6 | 4.4 |
| C2 | 0.45 | 7.0 | 4.6 |
| C7 | 0.20 | 5.4 | 3.4 |
| C8 | 0.725 | 10.3 | 9.5 |
| C9 | 0.20 | 5.4 | 3.3 |
| C10 | 0.725 | 10.3 | 9.5 |

WO 9847951, assigned to Stockhausen, Inc., describes the process of achieving hydrophobic coatings to obtain a superabsorbent with a swelling rate slower than that of the precursor material that was coated. A silicone treatment as described in WO 9847951 was applied to IM-5000, a superabsorbent available from Hoescht-Celanese (now BASF) of Portsmouth, Va. (superabsorbent identified as C4 in Table 1). The properties of the resulting samples were tested. Silicone oil was added to IM-5000 at coating levels of 0.15 g Si oil/150 g superabsorbent material (superabsorbent material identified as C5 in Table 1) and 2.25 g Si oil/150 g superabsorbent material (superabsorbent material identified as C6 in Table 1). The silicone oil used was NM4266-750 available from Huls Silicone GmbH (Nunchritz, Germany). Additionally, 0.75 gm of Ethylene Carbonate was added to the 150 g of superabsorbent material for both comparative examples C5 and C6. The findings were that while the examples exhibited hydrophobic characteristics in the dry state, these two samples both had Drop Penetration Values greater than 2 seconds. Detailed results are shown in Table 1.

As can be shown in Table 1, the Drop Penetration Time of composites made using superabsorbent materials C5 and C6 is greater than 2 seconds. In accordance with the present invention, a composite would have a Drop Penetration Time of about 2 seconds or less. Therefore, neither of these samples would fall within the definition of Class I superabsorbent materials of the present invention.

Another slow rate superabsorbent material with a hydrophobic coating is superabsorbent material C11, identified as W77553 (P15087) available from Stockhausen, Inc. As shown in Table 1, although the C11 superabsorbent material has an Absorption Time above the 5+10a² limit of the superabsorbent materials of the present invention, the hydrophobic nature of this superabsorbent material is noted by the ½ Float Saturation of 100%. Therefore, this sample would not fall within the definition of a Class I superabsorbent materials of the present invention.

As will be seen in the examples below, superabsorbent materials identified as Examples 1-8 in Table 1, when incorporated into composite materials show benefits in liquid handling. These benefits include wicking distance, wicking time, and maintaining low saturation levels.

### Example 9

The absorbent composites of the present invention may suitably possess constant or improved fluid intake and improved distribution of fluid over the life of the absorbent composite. One of the fundamental absorbent properties which is key to fluid distribution is the distance the fluid will travel through the absorbent material. One method of measuring the distance the fluid will travel is the Intermittent Inclined Wicking test, which is described in detail below. This test measures the distance saline moves for three intermittent exposures to liquid. As shown in Table 5, composites containing Class-I superabsorbent materials exhibit greater wicking distance for saline wicking through them. The absorbent composites are airformed and contain 50 wt % superabsorbent material as identified in Table 1 and 50 wt % CR1654 fibers, available from Alliance Forest Products, Coosa Pines, Ala., and are compared to composites of a similar composition made with a control superabsorbent material, FAVOR SXM-880 (sample C1 from Table 1) and the above mentioned CR1654 fibers. All the absorbent composites were 400 gsm basis weight, made at a composite density of 0.2 g/cc, and where cut to 33 cm long by 5.1 cm wide. Results show that the superabsorbent materials of the present invention may improve the absorbent utilization as evidenced by the greater distance saline may be wicked through the absorbent composite.

TABLE 5
Wicking Distance for 50 wt % SAM Absorbent Composites

| | Superabsorbent Identification | Wicking Distance |
|---|---|---|
| Class | (from Table 1) | (cm) |
| I | 1 | 18.5 |
| I | 2 | 22.3 |
| I | 3 | 33.0 |
| II | C1 | 16.0 |

### Example 10

Another important measure of distribution performance is the amount of time needed to absorb fluid in the Intermittent Inclined Wicking test. The amount of time taken to pick up the specified liquid amount was noted for the samples described above in Example 1. The sum of the time required to pickup each of the three liquid insults was computed. These results are shown in Table 6 below. Results show that for up to a certain Absorption Time (in this case, an Absorption Time of about 12.5 minutes) there is a reduction in the total pick up time. After that, there is an increase in the total pickup time. The exact value of the optimal absorption rate would depend on the superabsorbent material content and other composite properties.

TABLE 6
Total Pickup Time for 50 wt % SAM Absorbent Composites

| | Superabsorbent | Total Pickup | Absorption |
|---|---|---|---|
| | Identification | Time | Time |
| Class | (from Table 1) | (min) | (min) |
| I | 1 | 15.2 | 12.5 |
| I | 2 | 21.6 | 47 |
| I | 3 | 81.2 | 96.5 |
| II | C1 | 18.2 | 4 |

### Example 11

Another important feature of the superabsorbent materials of the present invention is their Gel Bed Permeability (GBP) for intake performance. Superabsorbent materials with various GBP and Absorption Time values, as indicated in Table 1, were converted into airformed 50% superabsorbent material absorbent composites with the remaining 50% consisting of CR1654 fibers, available from Alliance Forest Products, Coosa Pines, Ala. All the absorbent composites were 400 gsm basis weight, made at an absorbent composite density of 0.2 g/cc, and where cut to 12.7 cm long by 12.7 cm wide. The FIFE test was done on these samples to illustrate the effect of superabsorbent Absorption Time and GBP on the intake performance of absorbent composites. Results of the 3^{rd} insult intake times in the FIFE test are shown in Table 7.

TABLE 7
3^{rd} Insult Intake Time

| Superabsorbent | 3^{rd} Insult |
|---|---|
| Identification | Intake Time |
| (from Table 1) | (sec) |
| 7 | 25 |
| 6 | 28 |
| 2 | 65 |
| 4 | 45 |

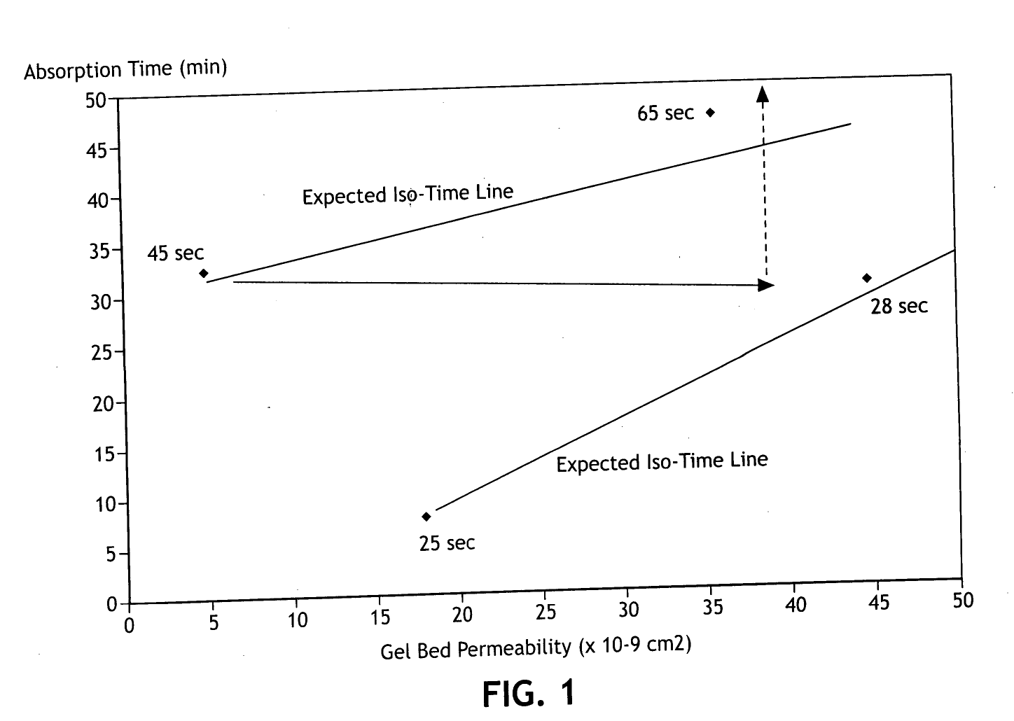

These results are additionally illustrated in FIG. 1. As indicated by the solid arrow line, superabsorbent materials with about the same Absorption-Time value tend to show reductions in intake times with an increase in GBP. The dotted arrow shows an increase in intake time when the GBP is maintained relatively constant and the Absorption Time is increased. The general trend seen is that as the Absorption Time is increased a greater GBP is required to provide more beneficial intake behavior. This is illustrated by the two lines (labeled “expected iso-time lines”). Having demonstrated the benefits of a slower superabsorbent material in the previous Examples, it can be seen that combining a slower absorption rate with a high GBP superabsorbent material would lead to further improvements in intake behavior.

### Example 12

The effectiveness of various superabsorbent material containing absorbent composites in a multi-layer design may be estimated using the Intake/Desorption test, measuring the ability of the upper layer to control several incoming insults and also its level of saturation over multiple insults. Table 8 shows the fractional saturation reached by the upper layer at the end of 3 insults as a ratio of the 0.5 psi saturated capacity of these materials. This ratio provides an estimate, therefore, of the reserve capacity that these layers have late in the life of the absorbent product. Smaller numbers indicate more reserve capacity. Clearly, a wide range of behavior was observed (about 0.18 to about 0.75).

TABLE 8
Fractional Saturation at End of 3^{rd} Insult

| Superabsorbent | Fractional |
|---|---|
| Identification | Saturation |
| (from Table 1) | after 3 Insults |
| 1 | 0.48 |
| 2 | 0.18 |
| 3 | — |
| 4 | 0.41 |
| 5 | — |
| 6 | 0.22 |
| 7 | 0.75 |
| 8 | 0.57 |

### Test Methods

The methods for performing the Saline Drop Penetration Test, the Gel Bed Permeability (GBP) test, the Floatability test, the Mean Particle Size test, and the Flooded Absorbency Under Zero Load (FAUZL) test used to distinguish Class I superabsorbent materials from Class II superabsorbent materials, are described below. Unless otherwise stated, the test fluid used in all the test methods described below is an aqueous 0.9 weight percent sodium chloride solution, such as that available from Ricca Chemical Company (Arlington, Tex.). Unless otherwise stated, all tests were conducted at about 70 degrees Fahrenheit and between 10 and 60% relative humidity.

Saline Drop Penetration Test

This test was designed to evaluate the hydrophobicity of a superabsorbent material/fluff absorbent composite using saline drops. The superabsorbent material/fluff ratio is 50/50, with 500 gsm basis weight and 0.2 g/cc density. The development of hydrophobicity is accelerated by baking the sample in a sealed container at 150° C. for 120 minutes. A pipette is used to put 10 saline drops, each about 0.05 grams, on different parts of the sample, and the penetration time of each drop into the sample is measured. The penetration time for each drop is measured independently. The time for each drop is started when that drop contacts the composite. The longest individual penetration time among the 10 drops is recorded as the Drop Penetration Value.

Baking for 120 minutes at 150° C. is equivalent to at least several months of laboratory, aging at ambient condition.

Flooded Absorbency Under Zero Load (FAUZL)

This test is designed to measure the saline absorption rate of particulate superabsorbent polymer (SAP). The test measures, as a function of time, the amount of saline absorbed by 0.160 grams of dry superabsorbent polymer when it is confined within a 5.07 cm² area under a determined nominal pressure of 0.01 psi (0.069 kPa). From the resulting absorption versus time data, the Absorption Time, to reach 60% of the equilibrium absorption capacity is determined.

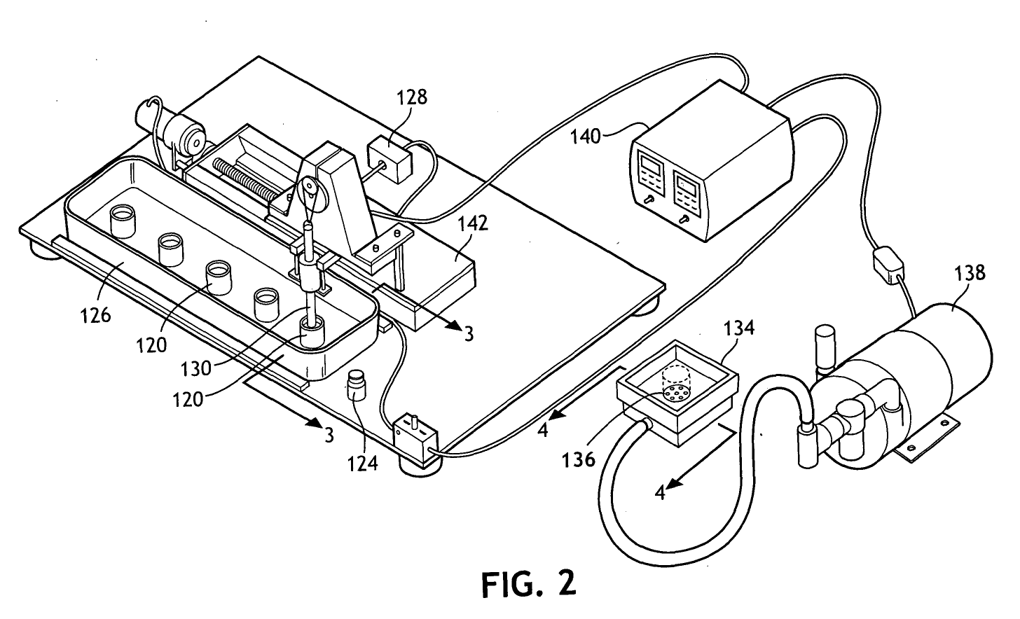

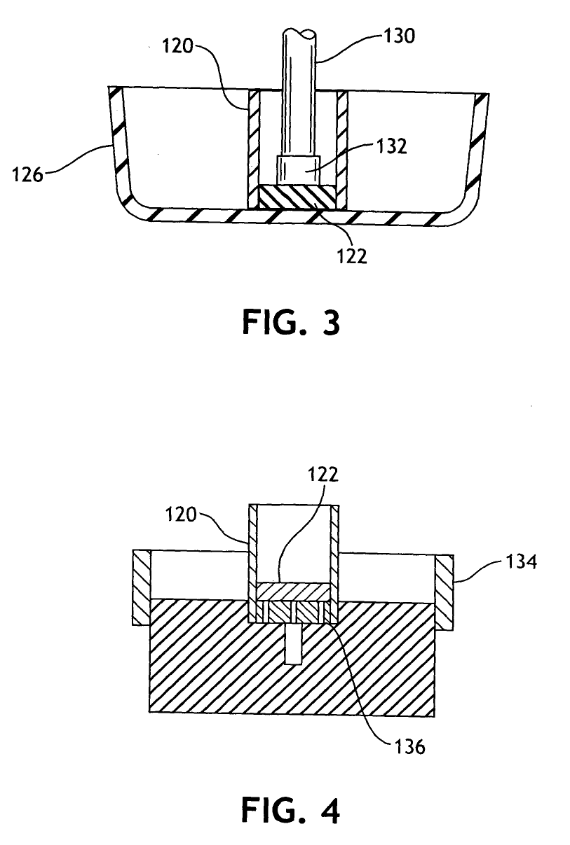

The test utilizes an electronic balance, accurate to 0.001 gram (200 gram minimum capacity); a cylinder group including: 1 inch (25.4 mm) inside diameter plastic cylinder 120 with a 100 mesh stainless steel screen affixed to the cylinder bottom and a 4.4 gram plastic piston disk 122 with a 0.995 inch (25.27 mm) diameter. The piston disk diameter is 0.005 inch (0.13 mm) smaller than the inside diameter of the cylinder. See FIG. 3. Also, aqueous 0.9 weight percent sodium chloride solution; a saline basin 126; a timer 140 capable of reading 120 minutes at one second intervals; and weighing paper (see FIG. 2).

A tapping device is positioned above the sample, to provide a consistent tapping onto the supporting piston disk, as illustrated in FIGS. 2 and 3. This tapping dislodges any trapped air surrounding the superabsorbent material and ensures that liquid wets the surface of the superabsorbent material. In this setup, a motor 128 rotates a shaft which drives a rod 130 along an up and down stroke. At the lower end of the rod is a rubber foot 132 which has a diameter of 13 mm, as illustrated in FIG. 3. The shaft stroke is 3 cm and it completes a full up and down stroke cycle every 0.7 seconds. The maximum pressure that the piston disk will apply to the SAP at impact is 0.16 psi (1.1 KPa).

With reference to FIG. 2, a fixture 134 has a vacuum port 136 that allows for the evacuation of interstitial liquid from the sample. The port accommodates the base of the cylinder group. When the cylinder group containing the sample is placed on the fixture, the free liquid is removed from between the superabsorbent particles. A suitable pump 138 applies a vacuum pressure to the sample of −13.5 psig (93.1 kPa) or less.

FIG. 2 shows the entire test setup. It should be noted that electronic timers 140 are suitably employed to control the duration of the tapping and vacuum devices. In this setup the tapping device also rests onto a slide 142 which would allow movement between multiple samples.

Procedure

1. Weigh out 0.160 grams (±0.001 grams) of superabsorbent material onto the pre-tared weighing paper. The particle size distribution is the “as received” particle size distribution of the superabsorbent material.

2. Slowly pour the superabsorbent material into the cylinder having the 100 mesh bottom. Avoid allowing the particles of superabsorbent material to contact the sides of the cylinder because particles may adhere. Gently tap the cylinder until the particles of the superabsorbent material are evenly distributed on the screen.

3. Place the plastic piston in the cylinder. Weigh this cylinder group and record the weight as the “cylinder group superabsorbent material amount.”

4. Fill the saline basin to a 1 cm height with the blood bank saline.

5. Place the cylinder group in the saline basin, directly below the shaft of the tapping device and start the timer. Start and operate the tapping device to tap for an eight second cycle.

6. One minute after the cylinder is placed into the basin, remove the cylinder, stop the timer and place the cylinder onto the vacuum platform, as illustrated in FIG. 4. Apply the vacuum at −13.5 psig (93.1 kPa) for a 6 second period.

7. Weigh the cylinder group and record the weight

8. Return the cylinder group to the basin below the tapping device and again start the timer. Note that the time between removing the cylinder group from the saline in step 6 to reintroducing the cylinder group to the saline in step 8 should not exceed 30 seconds. Repeat the initial sequence of soaking, removing, vacuuming, and weighing to gather and record data at cumulative soak times of 1, 5, 10, 15, 30, 45, 60, 75, 90, and 120 minutes.

9. Conduct the procedure described in steps 1-8 a total of three times.

Results and analysis

Calculate the grams of saline absorbed per gram of superabsorbent polymer, and plot as a function of cumulative soak time.

Determine the final equilibrium absorption capacity of the superabsorbent material: if there is less than a 5% change in the average capacity (average of three tests) of the superabsorbent material obtained at 90 and 120 minutes then use the capacity at 120 minutes as the equilibrium capacity, FAUZL. If there is greater than a 5% change in the average capacity, then the sample testing will need to be repeated and will need to include an additional sampling at a cumulative soak time of 200 minutes. Use the capacity at 200 minutes as the equilibrium capacity, FAUZL, for this latter situation.

Determine the interpolated time to reach 60% of the equilibrium absorption capacity. This is done by calculating the capacity at 60% of the equilibrium value, then estimating the corresponding time to reach this capacity from the graph. The interpolated time to reach 60% capacity (by this procedure), is obtained by performing a linear interpolation with the data points that lay to either side of the estimated time.

Calculate the arithmetic average interpolated time to reach 60% of the equilibrium capacity (average of three tests). This average value is referred to as “Absorption Time.”

Gel Bed Permeability (GBP)

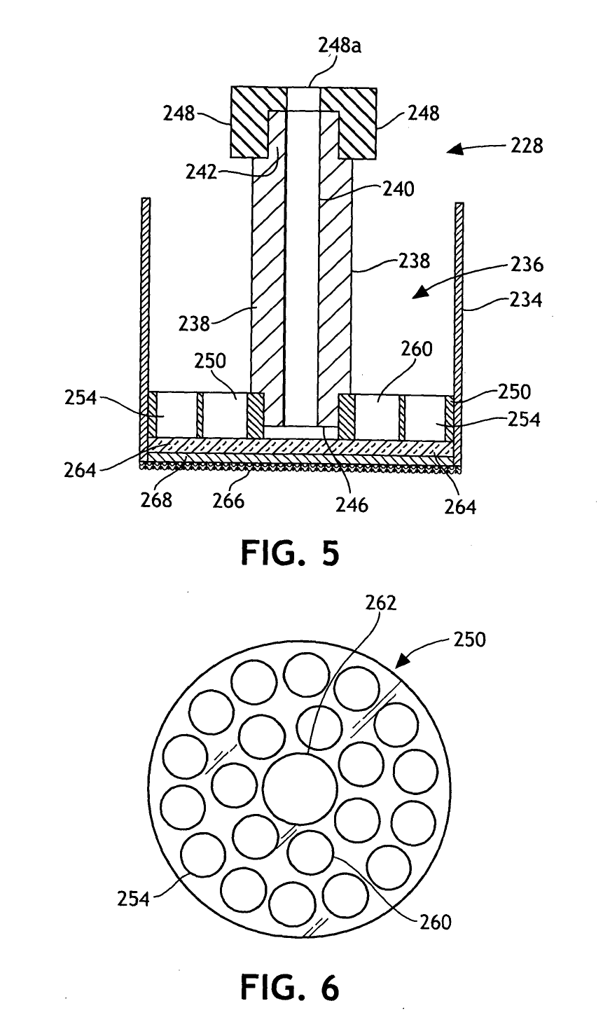

A suitable piston/cylinder apparatus for performing the GBP test is shown in FIGS. 5 and 6. Referring to FIG. 5, apparatus 228 consists of a cylinder 234 and a piston generally indicated as 236. As shown in FIG. 5, piston 236 consists of a cylindrical LEXAN® shaft 238 having a concentric cylindrical hole 240 bored down the longitudinal axis of the shaft. Both ends of shaft 238 are machined to provide ends 242 and 246. A weight, indicated as 248, rests on end 242 and has a cylindrical hole 248a bored through the center thereof. Inserted on the other end 246 is a circular piston head 250. Piston head 250 is sized so as to vertically move inside cylinder 234. As shown in FIG. 6, piston head 250 is provided with inner and outer concentric rings containing seven and fourteen approximately 0.375 inch (0.95 cm) cylindrical holes, respectively, indicated generally by arrows 260 and 254. The holes in each of these concentric rings are bored from the top to bottom of piston head 250. Piston head 250 also has cylindrical hole 262 bored in the center thereof to receive end 246 of shaft 238.

Attached to the bottom end of cylinder 234 is a No. 400 mesh stainless steel cloth screen 266 that is biaxially stretched to tautness prior to attachment. Attached to the bottom end of piston head 250 is a No. 400 mesh stainless steel cloth screen 264 that is biaxially stretched to tautness prior to attachment. A sample of superabsorbent material indicated as 268 is supported on screen 266.

Cylinder 234 is bored from a transparent LEXAN® rod or equivalent and has an inner diameter of 6.00 cm (area=28.27 cm²), a wall thickness of approximately 0.5 cm, and a height of approximately 5.0 cm. Piston head 250 is machined from a LEXAN® rod. It has a height of approximately 0.625 inches (1.59 cm) and a diameter sized such that it fits within cylinder 234 with minimum wall clearances, but still slides freely. Hole 262 in the center of the piston head 250 has a threaded 0.625 inch (1.59 cm) opening (18 threads/inch) for end 246 of shaft 238. Shaft 238 is machined from a LEXAN® rod and has an outer diameter of 0.875 inches (2.22 cm) and an inner diameter of 0.250 inches (0.64 cm). End 146 is approximately 0.5 inches (1.27 cm) long and is threaded to match hole 262 in piston head 250. End 242 is approximately 1 inch (2.54 cm) long and 0.623 inches (1.58 cm) in diameter, forming an annular shoulder to support the stainless steel weight 248. The annular stainless steel weight 248 has an inner diameter of 0.625 inches (1.59 cm), so that it slips onto end 242 of shaft 238 and rests on the annular shoulder formed therein. The combined weight of piston 236 and weight 248 equals approximately 596 g, which corresponds to a pressure of 0.30 psi (20,685 dynes/cm²) for an area of 28.27 cm².

When solutions flow through the piston/cylinder apparatus, the cylinder 234 generally rests on a 16 mesh rigid stainless steel support screen (not shown) or equivalent.

The piston and weight are placed in an empty cylinder to obtain a measurement from the bottom of the weight to the top of the cylinder. This measurement is taken using a caliper readable to 0.01 mm. This measurement will later be used to calculate the height of the gel bed. It is important to measure each cylinder empty and keep track of which piston and weight were used. The same piston and weight should be used for measurement when gel is swollen.

The superabsorbent layer used for GBP measurements is formed by swelling approximately 0.9 g of a superabsorbent material in the GBP cylinder apparatus (dry polymer should be spread evenly over the screen of the cylinder prior to swelling) with an aqueous 0.9 weight percent sodium chloride solution for a time period of about 60 minutes. The sample is taken from superabsorbent material which is prescreened through U.S. standard #30 mesh and retained on U.S. standard #50 mesh. The superabsorbent material, therefore, has a particle size of between 300 and 600 microns. The particles may be pre-screened by hand or automatically pre-screened with, for example, a Ro-Tap Mechanical Sieve Shaker Model B available from W. S. Tyler, Inc., Mentor, Ohio.

At the end of this period, the cylinder is removed from the fluid and the piston weight assembly is placed on the gel layer. The thickness of the swollen superabsorbent layer is determined by measuring from the bottom of the weight to the top of the cylinder with a micrometer. The value obtained when taking this measurement with the empty cylinder is subtracted from the value obtained after swelling the gel. The resulting value is the height of the gel bed H.

The GBP measurement is initiated by adding the NaCl solution to cylinder 234 until the solution attains a height of 4.0 cm above the bottom of superabsorbent layer 268. This solution height is maintained throughout the test. The quantity of fluid passing through superabsorbent layer 268 versus time is measured gravimetrically. Data points are collected every second for the first two minutes of the test and every two seconds for the remainder. When the data are plotted as quantity of fluid passing through the bed versus time, it becomes clear to one skilled in the art when a steady flow rate has been attained. Only data collected once the flow rate has become steady is used in the flow rate calculation. The flow rate, Q, through the superabsorbent layer 268, is determined in units of gm/sec by a linear least-square fit of fluid passing through the superabsorbent layer 268 (in grams) versus time (in seconds).

Permeability in cm² is obtained by the following equation:
K=[Q*H*Mu)]/[A*Rho*P]
Wherein:
K=Gel Bed Permeability (cm²);
Q=flow rate (g/sec);
H=height of gel bed (cm);
Mu=liquid viscosity (poise);
A=cross-sectional area for liquid flow (cm²);
Rho=liquid density (g/cm³); and,
P=hydrostatic pressure (dynes/cm²) [normally 3923 dynes/cm²].
   Floatability

The floatability test is designed to measure the floatability of particulate superabsorbent polymers (SAP).

The test utilizes a 500 ml beaker, two small-tipped spatulas, tweezers, plastic vials having an inner diameter of about 2-3 cm and a height of about 3-4 cm, saline, a weight balance and a timer.

First, spread 0.10 g of 300-600 μm superabsorbent material in a plastic vial and drop saline (0.9% NaCl) to designed pre-saturation levels (as determined herein below), then cover the vial. Wait for equilibrium to be established (about 200 minutes). Then, use a small-tipped spatula to take superabsorbent material out of the vial and separate superabsorbent material on a particle by particle basis. Place about 300 ml of saline in the beaker. Gently drop a particle of superabsorbent material from about 1 cm height above the saline surface on the surface of the saline. Start the timer when the particle touches the saline surface. Wait 45 seconds and then record whether the particle of superabsorbent material floats or sinks. A particle is designated as sinking if the whole particle sinks completely below the surface of the saline. Repeat until 20 particles have been tested. Calculate the percentage of particles of superabsorbent material that float. This equates to the “float percentage”. Graph the float percentage as a function of saturation.

To prepare the pre-saturation level, use a small vial with a cover. “Saturation” is defined as: Saturation=(liquid weight/dry superabsorbent material weight) in g/g normalized to the equilibrium FAUZL absorption capacity of the superabsorbent (as defined above) in g/g. Weigh 0.1 g of superabsorbent material. Drop the superabsorbent material into the desired amount of saline to achieve the desired saturation level (liquid/solid g/g). Shake the container and let the saline mix with the superabsorbent material to form as homogeneous of a mixture as possible. Seal the container and wait to the equilibrium state (about 200 minutes). Then, start the floatability test.

Mean Particle Size Test Method

The particle size distribution of superabsorbent material is determined by placing a known weight of a sample in a Ro-Tap mechanical sieve shaker with U.S. standard sieves and shaking it for a specified period of time under defined conditions. Sample sections that are retained on each sieve are used to compute the mean particle size.

25±0.1 grams of superabsorbent is weighed and set aside for testing. The sieves are stacked on to the Ro-Tap in the following order from bottom to top: bottom pan, 325 mesh, 170 mesh, 50 mesh, 30 mesh, and 20 mesh. The superabsorbent sample weighed above is poured into the top sieve (#20) and then the sieve is covered. The Ro-Tap is allowed to run for 10 minutes and then stopped. The amount of superabsorbent retained on each pan is noted. The mass fraction of superabsorbent retained on each sieveᵢ is referred to as mᵢ, and is computed by taking the ratio of the retained mass of superabsorbent to the total mass of superabsorbent. For the purpose of computing the mean particle size, it is assumed that all the particles retained on a particular sieve have a size rᵢ, equal to the average of the sieve above and sieve it is retained on. For example, superabsorbent retained on the 50 mesh screen would be inferred to all be 450 μm (average of 300 um corresponding to the 50 mesh and 600 um corresponding to the 30 mesh). Samples retained on the 20 mesh sieve are assumed to be 1000 μm size. Samples retained on the pan are assumed to be 22 um (average of 44 um corresponding to the 325 mesh and 0 um corresponding to the pan). The mean particle size is then computed as:
MeanParticleSize=Σmᵢ*rᵢ
For Testing Absorbent Composites:

The test methods for the Fluid Intake Flowback Evaluation test, the Intake/Desorption test, the 0.5 psi Saturated Capacity Test, and the Intermittent Inclined Wicking Test are described below:

Fluid Intake Flowback Evaluation Test

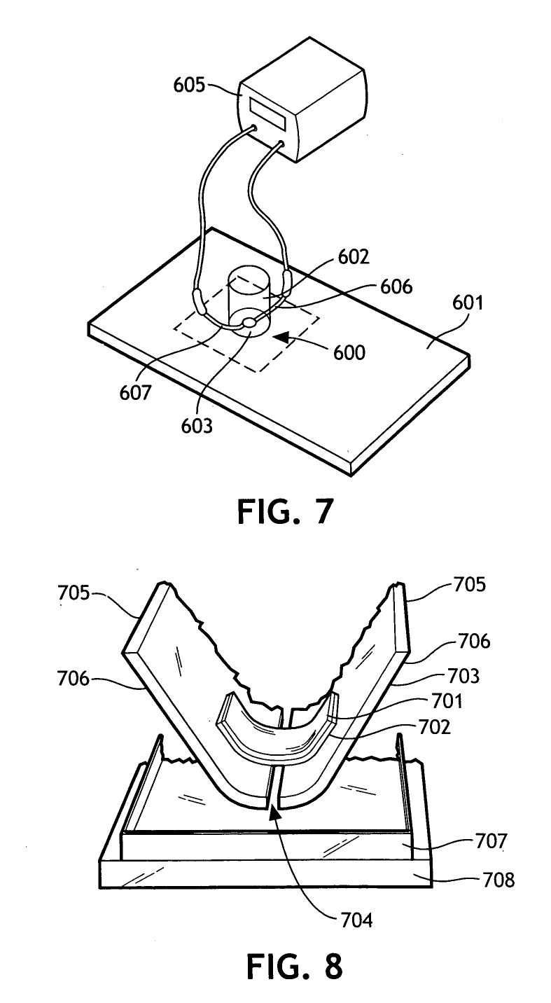

The Fluid Intake Flowback Evaluation (FIFE) test determines the amount of time required for an absorbent composite to intake a preset amount of fluid. A suitable apparatus for performing the FIFE test is shown in FIG. 7.

An absorbent composite of superabsorbent material and fluff, or fluff only, is air-formed on tissue to a desired basis weight and density. The absorbent composite is cut to the desired size, in this case, the absorbent composite 600 is cut to a 5 inch (12.70 cm) square. The absorbent composite 600 is placed under the FIFE test pad 601. The test pad 601 is a flexible conformable silicon bed that is 10 inches (25.4 cm) by 20 inches (50.8 cm). The test pad 601 is constructed using Dow Corning 527 primeness silicon dielectric gel and wrapping it in shrinkable plastic wrapping. This test pad 601 is made with a sufficient thickness to produce a pressure of approximately 0.03 psi (2,069 dynes/cm²). The test pad 601 contains a Plexiglas cylinder 602 with an inner diameter of 5.1 cm and an outer diameter of 6.4 cm and the bottom of the cylinder has a cap 603 with a 1 inch (2.54 cm) circle bore in the center where the test fluid comes in direct contact with the absorbent composite 600. The center of the cylinder is located 6.75 inches (17.15 cm) down from the top edge of the test pad 601 and is centered from side to side (5 inches (12.70 cm) from the edge). An automated controller 605 can be connected to electrodes 606 and 607 that auto-initiate the test upon the entry of the test fluid. This can eliminate tester variability. The test fluid is suitably an aqueous 0.9 weight percent sodium chloride solution.

The test is run by placing the absorbent composite 600 under the silicon test pad 601. The desired amount of fluid is dispensed from a positive displacement pump. The fluid amount in this case is calculated according to the composition of the absorbent composite. For example, the fluid amount for a 400 gsm absorbent composite of size 5 inch (12.70 cm) square consisting of 50% superabsorbent material and 50% fluff is calculated by assuming the superabsorbent capacity is 30 g/g and the fluff capacity is 6 g/g. The total amount of capacity of the absorbent composite in grams is calculated and 25% of this amount is one insult. The fluid is dispensed at a rate of approximately 10 ml/sec. The time in seconds for fluid to completely drain from the cylinder 602 is recorded.

After a 15 minute wait, a second insult is done and after another 15 minute wait, the third and final insult is done. The FIFE Intake Rate for each insult is determined by dividing the insult fluid amount in milliliters by the time necessary for the fluid to drain from the cylinder 602 in seconds.

If during the test, leakage of fluid occurs from the top, bottom, or sides of the absorbent composite, the amount of leaked fluid should be measured. In this case, the FIFE Intake Rate for each insult is determined by subtracting the leaked fluid amount from the insult fluid amount and then dividing this quantity by the time for the fluid to drain from the cylinder 602 in seconds.

Intake/Desorption Test

The Intake/Desorption test measures the intake and desorption capability of a superabsorbent material or absorbent composite. A suitable apparatus for performing the Intake/Desorption test is shown in FIG. 8.

An absorbent composite may consist of superabsorbent material and fluff, or fluff only. In this case, absorbent composites consisting of superabsorbent material and fluff were air-formed on tissue to a desired basis weight and density. The absorbent composite is then cut to the desired size, in this case, the absorbent composite is cut to 2.5 inches (6.35 cm) by 6 inches (15.24 cm). The dry weight of the absorbent composite 701 to be tested is recorded. The test absorbent composite 701 is placed on a piece of polyethylene film 702 that is the exact size of the test absorbent composite 701 and centered in a Plexiglas cradle 703 such that the length of the absorbent composite (15.24 cm) is perpendicular to the slot 704 in the bottom of the cradle 703. The cradle 703 has a width of 33 cm. The ends 705 of the cradle 703 are blocked off at a height of 19 cm to form an inner distance of 30.5 cm and an angle between the upper arms of 60 degrees between upper arms 706 of cradle 703. The cradle 703 has a 6.5 mm wide slot 704 at the lowest point running the length of the cradle 703. The slot 704 allows run-off from the test absorbent composite 701 to enter tray 707. The amount of run-off is recorded by a balance 708 readable to the nearest 0.01 g. A pre-set amount of liquid is delivered in the center of the test absorbent composite 701 at a desired rate. In this case the amount is 100 ml at a rate of 15 ml/sec and ½ inch (1.27 cm) above the sample. The amount of run-off is recorded.

The test absorbent composite 701 is immediately removed from the cradle 703 and placed on a 2.5 inches (6.35 cm) by 6 inches (15.24 cm) pre-weighed dry pulp fiber/superabsorbent material desorption pad having a total basis weight of 500 gsm and a density of about 0.20 g/cc and a superabsorbent material wt % of 60 in a horizontal position under 0.05 psi pressure for 15 minutes. The superabsorbent material is suitably FAVOR 880, available from Stockhausen, Inc. (Greensboro, N.C.). The pulp fiber is suitably Coosa 1654, available from Alliance Forest Products (Coosa Pines, Ala.). This pressure is applied by using a Plexiglas plate and any necessary additional weight to uniformly apply 0.05 psi pressure over the entire 2.5 inch by 6 inch pad area. After the 15 minutes, the desorption pad weight is recorded and the test absorbent composite 701 is placed back in the cradle 703 in the same position and a second insult of 100 ml is done. After the amount of run-off is recorded, the test absorbent composite 701 is once again placed on a pre-weighed dry desorption pad under 0.05 psi (dynes/cm²) load for 15 minutes. After 15 minutes, a weight of the desorption pad is recorded. The absorbent composite 701 is placed back in the cradle 703 for a third insult.

The amount of run-off is recorded and the test absorbent composite 701 is placed on a dry pre-weighed desorption pad under 0.05 psi pressure for 15 minutes. The amount of fluid picked up in g/g for each insult is calculated by subtracting the run-off from 100 ml and dividing by the dry weight of the test absorbent composite 701. A particularly useful measure of the ability of an absorbent composite to exhibit superior fluid intake of multiple insults over the life of the absorbent composite is to divide the 3^{rd} insult pickup value by the 1^{st} insult pickup value. The saturation level in the absorbent composite after each insult is determined by considering the volume of each insult, the volume of liquid run-off during each insult, and the volume of liquid transferred to the desorption pad for each insult. To determine the saturation level in the test composite after the 3^{rd} liquid insult the following equations are used:
Liquid Level in Test Composite after 3^{rd} insult=3×100 gm−1^{st} insult run-off (gm)−2^{nd} insult run-off (gm)−3^{rd} insult run-off (gm)−(wet-dry desorption pad used for 1^{st} insult (gm))−(wet-dry desorption pad used for 2^{nd} insult (gm))−(wet-dry desorption pad used for 3^{rd} insult(gm))
Saturation Level in Test Composite after 3^{rd} insult=Liquid Level in Test Composite after 3^{rd} insult/(0.5 psi saturated capacity (g/g)*dry mass of test composite (gm))
0.5 psi Saturated Capacity Test Method

Saturated Capacity Procedure test measured the capacity of an absorbent composite or absorbent product. The absorbent composite was cut to the preferred size and pressed to the preferred density. A dry weight of the absorbent composite as recorded. The absorbent composite was placed in 0.9% (w/v) NaCl solution for 20 minutes. The level of the NaCl solution was such that the absorbent composite was fully submerged. After 20 minutes, the absorbent composite was removed from the NaCl bath and placed horizontally on a screen to let drip for 1 minute. 0.5 psi pressure was applied evenly to the composite for 5 minutes. The wet weight of the absorbent composite was recorded. The calculation for saturated capacity was as shown in Equation 1.

$$SATCAP ( g / g ) = \frac{( wetweight ( g ) - dryweight ( g ) )}{( dryweight ( g ) - nonabsorbentweight ( g )} \qquad Equation 1$$

The nonabsorbent weight has a value of zero for composites.

Intermittent Inclined Wicking Test

Details of this test apparatus can be found in European Publication 761 192 A2 in the section titled “Wicking Parameter”. An absorbent composite sample is cut to 2 inches width and 13 inches length for this test. The weight and bulk of the sample are noted. The sample is placed on an incline of 30° to the horizontal direction and saline is introduced at the low end of the sample. The saline reservoir is placed on a balance that monitors the amount of liquid being removed from the reservoir. The sample is allowed to pick up about 25% of its saturated capacity from the dry state. The time taken to absorb this amount of liquid is noted and then the liquid reservoir is shut off for 30 minutes. At this time, the liquid reservoir is opened again and the sample is allowed to pick up an additional 25% of its saturated capacity. Following a 30 minute wait period at the end of the second liquid absorption, the sample is allowed to pick up liquid a third time for an additional 25% of its saturated capacity. The total of all three liquid absorption times (not accounting for the 30 minute wait times) is reported as the total time taken to absorb the liquid. The position of the liquid front at the end of the third liquid absorption step is reported as the distance to which liquid wicks during the experiment.

1. An absorbent composite comprising superabsorbent material, wherein the superabsorbent material has an Absorption Time of about 5+10 a² minutes or greater, wherein a is the mean particle size of the superabsorbent material in millimeters, a liquid capacity of about 15 g/g or greater, a Drop Penetration Value of about 2 seconds or less, and a ½ Float Saturation of about 50% or less.

2. The absorbent composite of claim 1, wherein the superabsorbent material has a liquid capacity of about 25 g/g or greater.

3. The absorbent composite of claim 1, wherein the superabsorbent material has an Absorption Time of about 10+10 a² minutes or greater.

4. The absorbent composite of claim 1, wherein the superabsorbent material has a Gel Bed Permeability of about 20×10⁻⁹ cm² or greater.

5. The absorbent composite of claim 1, wherein the superabsorbent material is substantially homogeneously distributed within the absorbent composite.

6. The absorbent composite of claim 1, wherein the superabsorbent material is zoned within a target area of the absorbent composite.

7. The absorbent composite of claim 1, wherein the absorbent composite comprises a plurality of layers and the superabsorbent material is located in a layer of the absorbent composite.

8. The absorbent composite of claim 7, wherein the superabsorbent material is zoned within a target area of the layer of the absorbent composite.

9. The absorbent composite of claim 1, wherein the superabsorbent material is zoned along the perimeter of the absorbent composite.

10. The absorbent composite of claim 1, wherein the superabsorbent materials are laminated onto a substrate.

11. A disposable product comprising the absorbent composite of claim 1.

12. A disposable product comprising an absorbent composite, wherein the absorbent composite comprises a superabsorbent material having an Absorption Time of about 5+10 a² minutes or greater, wherein a is the mean particle size of the superabsorbent material in millimeters, a liquid capacity of about 15 g/g or greater, a Drop Penetration Value of about 2 seconds or less, and a ½ Float Saturation of about 50% or less.

13. The disposable product of claim 12, wherein the superabsorbent material has a liquid capacity of about 25 g/g or greater.

14. The disposable product of claim 12, wherein the superabsorbent material has an Absorption Time of about 10+10 a² minutes or greater.

15. The disposable product of claim 12, wherein the superabsorbent material has a Gel Bed Permeability of about 20×10⁻⁹ cm² or greater.

16. The disposable product of claim 12, wherein the superabsorbent material is substantially homogeneously distributed within the absorbent composite.

17. The disposable product of claim 12, wherein the superabsorbent material is zoned within a target area of the absorbent composite.

18. The disposable product of claim 12, wherein the absorbent composite comprises a plurality of layers and the superabsorbent material is located in a layer of the absorbent composite.

19. The disposable product of claim 18, wherein the superabsorbent material is zoned within a target area of the layer of the absorbent composite.

20. The disposable product of claim 12, wherein the superabsorbent material is zoned along the perimeter of the absorbent composite.

21. The disposable product of claim 12, wherein the superabsorbent materials are laminated onto a substrate.

22. The disposable product of claim 12, wherein the disposable product is selected from a diaper, an adult incontinence product, a bed pad, a sanitary napkin, a tampon, a tissue, a wipe, a tissue, a bib, a wound dressing, or food packaging.

23. An absorbent disposable garment comprising:
a body-side liner;
an outer cover superposed in facing relation with the body-side liner; and,
an absorbent composite located between the body-side liner and the outer cover, wherein the absorbent composite comprises superabsorbent material having an Absorption Time of about 5+10 a² minutes or greater, wherein a is the mean particle size of the superabsorbent material in millimeters, a liquid capacity of about 15 g/g or greater, a Drop Penetration Value of about 2 seconds or less, and a ½ Float Saturation of about 50% or less.
